(19) United States
(12) Patent Application Publication
(10) Pub. No.: US 2002/0174172 A1
(43) Pub. Date: Nov. 21, 2002

(54) Mechanism to control compilation and communication of the client-device profile by using unidirectional messaging over a broadcast channel

(76) Inventor: Atul N. Hatalkar, Chandler, AZ (US)

Correspondence Address: FISH & RICHARDSON, PC, 4350 LA JOLLA VILLAGE DRIVE, SUITE 500, SAN DIEGO, CA, 92122, US

(21) Appl. No.: 09/823,029

(22) Filed: Mar. 29, 2001

(51) Int. Cl. G06F 15/16

(52) U.S. Cl. 709/203

(57) ABSTRACT

In an embodiment, a communication system may include a system host that transmits messages to a number of client devices, which may be dynamically grouped. The target client(s) may receive the message, compile the requested information, initiate a connection with the host over a back channel, and transmit the requested information to the host.

### BACKGROUND

A broadcast communication system may include a host that transmits messages to a number of client devices. An example of a broadcast communication system is a digital cable system that transmits television signals over a cable line from a head end to set-top appliances connected to customers' televisions. The head end may transmit general system signals, such as basic cable channels, to all set-top appliances in the system. The head end may also send client-specific signals, including pay-per-view programs or authorizations that are addressed to the set-top appliances of specific customers that ordered the pay-per-view programs.

At any given time, there may be many messages being transmitted over the system, many of which may not be intended for all of the client devices. At a certain traffic level and demand for particular messages, individually addressing client-specific messages may be cumbersome and time-consuming for the host processor and may reduce the available bandwidth in the communication link.

### BRIEF DESCRIPTION OF THE DRAWINGS

FIG. 1 is a schematic diagram of a communication system capable of dynamically grouping client devices according to an embodiment.

FIG. 2 is a schematic representation of a message format including group addressing according to an embodiment.

FIG. 3 is a flowchart illustrating an operation for updating group memberships according to an embodiment.

FIG. 4 is a flowchart illustrating an operation for receiving group directed messages according to an embodiment.

FIG. 5 is a schematic representation of a client profile request message according to an embodiment.

FIG. 6 is a flowchart illustrating an operation for a host to initiate a communication with a client over a back channel according to an embodiment.

### DETAILED DESCRIPTION

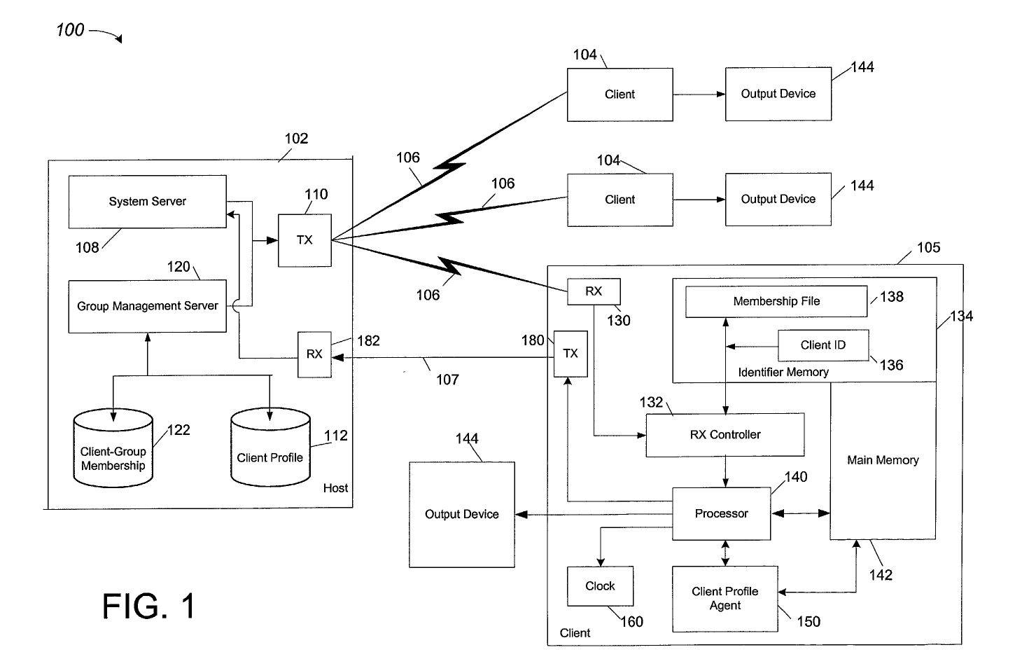

FIG. 1 illustrates a communication system 100 according to an embodiment that may dynamically assign client devices to groups in the system. The system may include a host 102 that may broadcast messages to client devices 104, 105 in the system. The messages may be addressed as general call messages intended for all client devices in the system, client-specific messages intended for particular client devices, and/or group-specific messages intended for client devices belonging to particular groups in the system.

The host 102 may create, modify, and remove groups from the system. A group may include one or more member client devices, and a client device may be a member of none, one, or many groups. The groups may be dynamic, with group memberships changing over time.

The host 102 may transmit messages to client devices over a broadcast channel in a communication link 106. The communication link 106 may be a transmission line such as co-axial cable, fiber optic, plain old telephone system (POTS), or digital subscriber line, or it may be a wireless RF signal transmitted via satellite or base stations to a receiver, such as a dish, or a transceiver, such as those used in wireless hand-held devices. The communication link 106 may include a combination of such communication media.

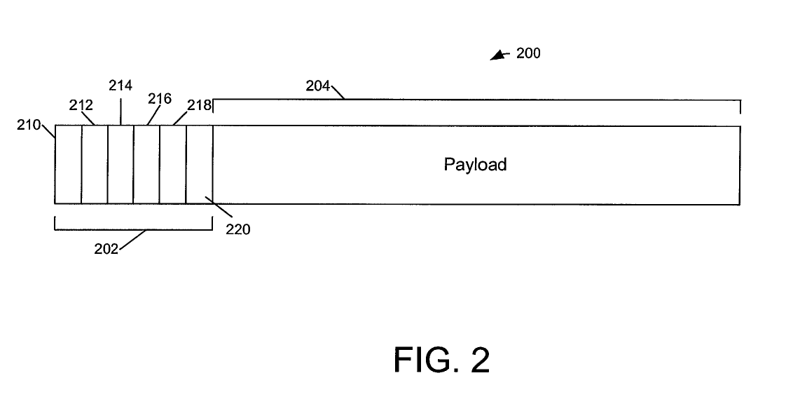

A system server 108 may format messages and transmit them from a transmitter 110. The system server 108 may format the messages into packets 200 that include a header portion 202 and a payload portion 204 as shown in FIG. 2. The header portion 202 may include a client identifier for a client specific message, or a group identifier for a group-specific message. The payload portion 204 may include content such as audio and video signals for television programs and movies, data for electronic program guides and advertisements, software modules for video games, and system management messages. The system management messages may include, for example, authorization information, billing information, and diagnostic and maintenance software modules for servicing the client device 104, 105.

In an embodiment, the header portion 202 may include a number of fields. These fields may include, for example, a protocol version field 210, a target type field 212, a target field 214, a message identifier field 216, a message type field 218, and a payload size field 220.

The value in the protocol version field 210 may identify the version of the protocol used to describe the message.

The value in the target type field 212 may be a Boolean flag which identifies the identifier in the target field as either a client identifier, e.g., value=0, or a group identifier, e.g., value=1. The value in the target field 214 identifies the intended target of the message, which may be a particular client or a group of clients.

The host 102 may transmit messages multiple times, e.g., in a message carousel, to capture client devices that are off or otherwise unavailable at the time of the first transmission. The value in the message identifier field 216 may identify a message as a new message from the host 102, or a repeated message.

The value in the message type field 218 may indicate the type, or purpose, of the message. These types may include, for example, test messages, software download schedule information, and alert messages.

The value in the payload size field 220 may indicate the number of bytes in the payload portion 204. The payload size value may be compared to an actual count of the bytes received in the payload as an error checking measure.

The host 102 may include a client profile database 112. A client device may have an individual client identifier. That client identifier may be associated with profile information for that client device in the client profile database 112. The profile information may include information about a particular client device and customer. This information may include, for example, services and/or products the client device is authorized to receive, orders and subscriptions placed by the customer, geographic and contact information, and demographic information. The demographic information may include, for example, the customer's household income, number and age of children, interests, service and program preferences, number and type of consumer appliances, and historical information, such as payment records, and past subscriptions and orders placed by the customer. The profile information may also include diagnostic information concerning the client device 105, for example, whether a hard drive is reaching capacity or history of software errors.

The system may include a back link 107 between the client device 105 and the host 102. The back link 107 may be used by the client device 105 to transmit the client profile information from a transmitter 180 to a receiver 182 at the host 102. The back link 107 may include a back channel in the communication link 106 or may include a separate communication link.

In an embodiment, the back link 107 may be a relatively low bandwidth, wired connection, e.g., a POTS or cable line, and may be a link that is not persistently available. In this embodiment, the client device 105 may be responsible for initiating communication with the host 102 over the back link 107. The client device 105 may initiate such communication periodically according to an update schedule. The client device may initiate the communication automatically in response to an event, for example, expiration of a time period, or the client device 105 may prompt the end user to initiate the communication, e.g., with a displayed icon and/or text instruction.

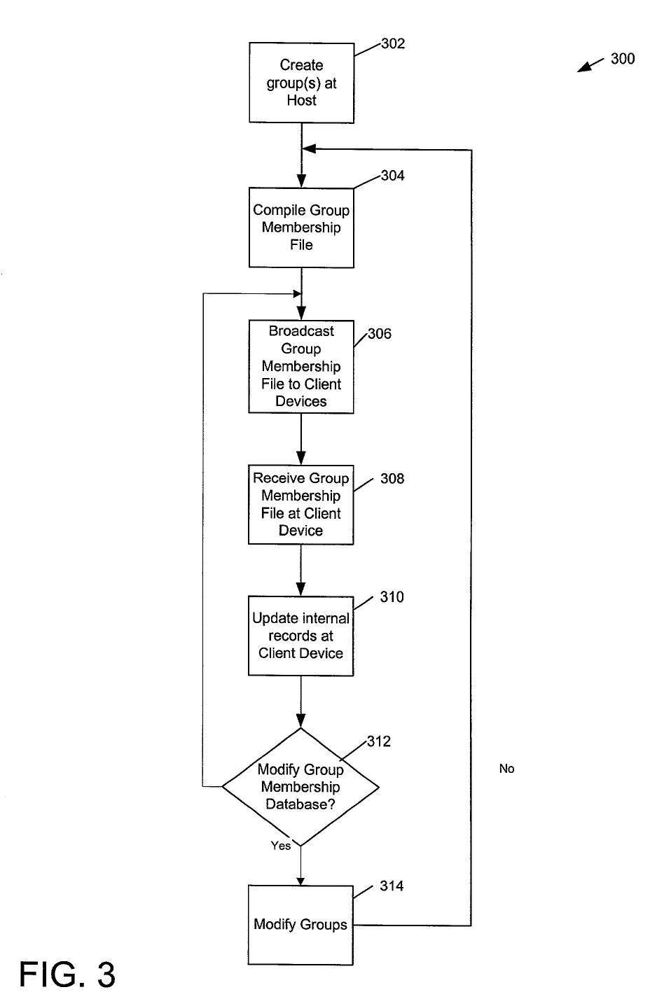

FIG. 3 illustrates an operation 300 for updating dynamic groups in the system according to an embodiment. A group management server 120 may include hardware and software for creating new groups and modifying existing groups based on information in the client profile database 112. The group management server 120 may create a new group from information in the client profile database 112 in block 302. The group may include member clients that share a common criterion. For example, a group may be created for the client devices of customers that have ordered a particular service, for example, a premium channel service in a digital cable system. Another group may be created for the client devices of customers that have ordered a particular product, for example, a video game software module. Another group may be created for customers that belong to certain demographic or geographic groups which may be targeted by certain advertisers. For example, households that report children between the ages of three and nine years may be included in a group that is targeted to receive an electronic catalog of age appropriate toys.

Each group may have a group identifier. The client identifiers of member clients in the group may be linked or otherwise associated with that group identifier in a client-group database 122. As shown in Table 1, a client device may belong to more than one group.

TABLE 1

| Client ID | Group ID |
|---|---|
| 0x00000007 | 0x00001000 |
| 0x00000007 | 0x04000000 |
| 0x00000010 | 0x04000000 |

The group management server 120 may compile a general membership file from the contents of the client-group database 122 in block 304 for transmission to the client devices 104, 105. The general membership file may be a data structure organized as, for example, a file, a database, or a table. The client identifiers of member clients may be mapped to the corresponding group identifier in the general membership file. The compiled general membership file may be transmitted to the client devices in block 306.

The general membership file may be relatively large, and the host may compress the general membership file prior to transmission to conserve the processing resources of the client devices. The general membership file may also be encoded with error checking data.

The client device 105 may include a receiver connected to the communication link 106 for receiving the general membership file and messages from the host 102, a receiver controller 132 to inspect transmissions from the host, and an identifier memory 134. The identifier memory 134 may include a client identifier file 136 to store the individual client identifier of the client device and an internal membership file 138 to store the group identifier(s) of the group(s) in which the client device 105 is currently a member.

Client devices in the system may receive the general membership file in block 308 and use it to update their internal membership files in block 310. When the client device 105 receives the general membership file, the receiver controller 132 may inspect the file for group identifiers associated with the client identifier, and compare those group identifiers to the group identifiers currently stored in the identifier memory 134. Based on this comparison, the receiver controller 132 may store new group identifiers that are associated with the client identifier in the identifier memory 134. The receiver controller may also delete group identifiers that are no longer associated with the client identifier from the identifier memory 134. Thus, the receiver controller 132 may update the internal membership file 134 to agree with the group-client associations contained in the last general membership file transmitted.

The host 102 may transmit the general membership file repeatedly to account for client devices that were not available for reception at the time the general membership file was first transmitted. Such unavailable client devices may include those that were off or out of reception range at the time of the first transmission. Unavailable client devices may also include devices that were busy handling operations having a higher priority than receiving and handling the general membership file. For example, if a customer is using the client device 105, for example, to decode a video or voice signal, the client device 105 may ignore the general membership file and wait for the next transmission.

To reduce the number of unavailable client devices, the host may transmit the general membership file at off-peak times, when many client devices may be idle and better able to utilize their processor resources to handle such system functions. For example, in a digital cable system, the general membership file may be transmitted when most customers are not watching television, for example, at 3 a.m. In a wireless phone/PDA system, the general membership file may be transmitted every several hours in carousel fashion.

The group management server 120 may modify the groups in the client-group database 122 over time in block 314 in response to changed circumstances. For example, a new group may be generated for a new service provided by the host 102. An existing group may be deleted when a service campaign ends. New members may be added to a group, for example, new subscribers to a service. Existing members may be removed from a group, for example, subscribers who cancel or are delinquent in payment.

When the group management server 120 modifies the groups in the client-group database 122, the operation 300 may return to block 304 and compile a new, updated general membership file. The updated general membership file may be transmitted upon being compiled or at a next scheduled transmission time.

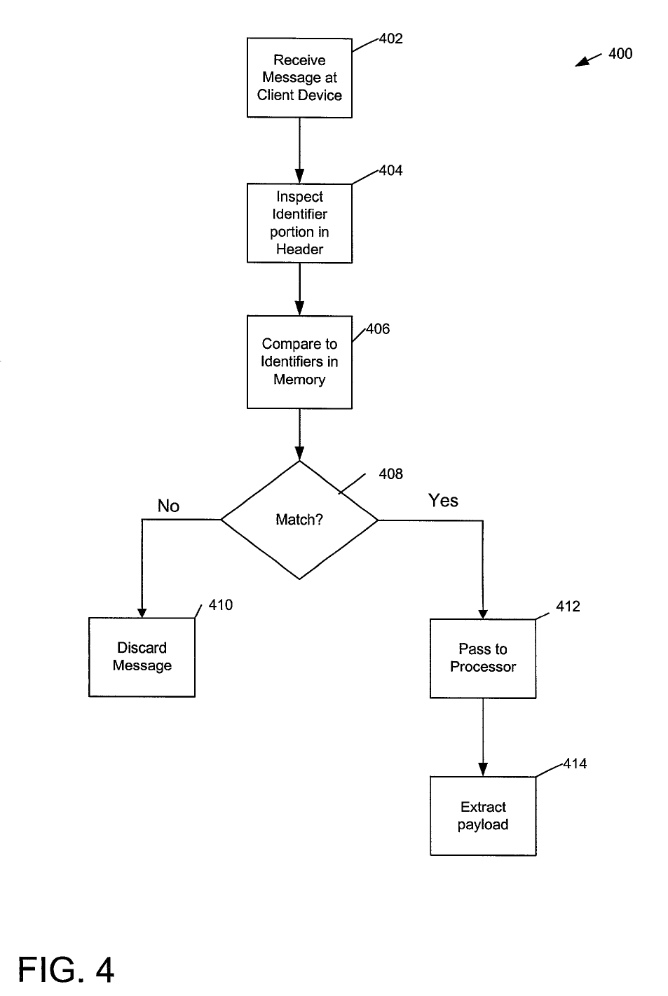

FIG. 4 illustrates an operation 400 for updating dynamic groups in the system. When the client device 105 receives a message in block 402, the receiver controller 132 may inspect the identifier portion 206, 208 of the message in block 404 and compare it to the client identifier and the group identifier(s) in the identifier memory in block 406. If the identifier in the header portion does not match any identifier in the client device's identifier memory 134 in state 408, the message may be discarded in block 410. If the identifier portion 206, 208 matches any identifier in the identifier memory 134, the message may be passed on to a processor 140 in block 412.

The processor 140 may include a microprocessor for executing instructions stored in a memory 142 and processing data. The processor may include a signal processor, such as a digital signal processor (DSP) for processing compressed and encoded digital signals, for example, digital video and audio signals. The processor 140 may extract the contents of the payload portion 204 in block 414 and store the payload in the memory 142 and/or prepare the payload for output to an output device 144. The output device 144 may include, for example, a television, a liquid crystal display (LCD) or cathode ray tube (CRT) display screen, and/or a speaker.

Although the client device 105 may be responsible for making the actual connection with the host 102 over the back link 107, there may be instances in which the host 102 may need to initiate communication from the client device 105 over the back link 107. For example, the host 102 may require client profile information from the client device 105 before the next scheduled transmission.

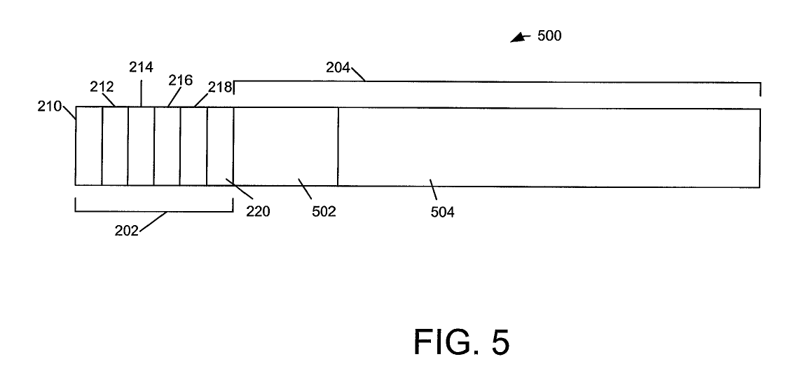

In an embodiment, the message types may include a client profile request message. FIG. 5 illustrates a client profile request message 500. The client profile request message type may be identified in the message type field 218 of the header portion 202. The payload portion 204 of the client profile request message may include a profile type field 530 and a date/time field 532.

The value in the profile type field may indicate a type of the requested client profile information. These may include, for example, a profile based on hardware usage in the client device, fault types experienced by the client device, or applications the client device has downloaded.

The value in the date/time field may indicate a target date/time by when the client device may be required to communicate the requested profile to the host 102. The client device may include a clock 160 to output a current date/time to the processor 140 when requested.

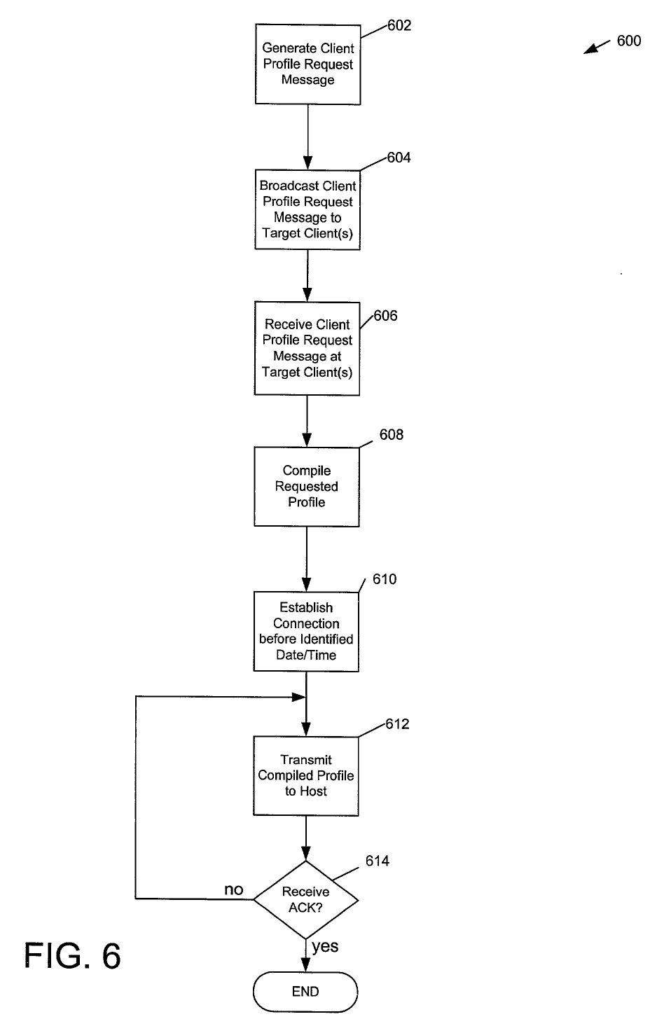

FIG. 6 illustrates an operation 600. The host 102 may generate a client profile request message for a particular client or group of clients in block 602 and transmit the message over the communication link 106 to a target client(s) in block 604.

The target client(s) may receive the message in block 606 and compile the requested client profile information in block 608 in response to the request. The client profile request may be assigned a high priority in the system. The client profile agent may compile the requested profile as soon as possible after receiving the request, but in any event no later than the target date/time.

At some time before the target date/time, the client device 105 may establish a connection with the host 102 over the back link 107 in block 610 and transmit the requested profile information to the host 102 in block 612. If the client device has already established a connection with the host 102 when the client device 105 is ready to transmit the requested profile, for example, during a scheduled profile transmission, the client device 105 may piggy-back the requested profile transmission on the pre-established connection.

In an embodiment, the back link 107 is a bi-directional communication channel. The host 102 may transmit an acknowledgement (ACK) signal to the client device 105 after successfully receiving the requested profile information. The client device 105 may wait for the ACK signal for a preset period of time. If the client device 105 does not receive the ACK signal within the preset time period in block 614, the operation 600 may return to block 612, in which case the client device may retransmit the requested profile information some time before the identified date/time.

In an embodiment, a digital cable system may include client devices with processors that may be serviced with downloaded maintenance software. Consider a situation in which a number of subscribers in a geographic area, for example, Orange County, Calif., report malfunctioning client devices, the malfunctions being similar and correctable by downloading a maintenance software module to the malfunctioning client devices. The host 102 may generate a group comprising client devices in Orange County, for example, by zip code. The host 102 may generate a client profile request message 500 requesting information indicative of the reported malfunction before an identified date and time, and format the group identifier for the generated group into the target field of the message. The host 102 may then broadcast this message to all client devices in the system. The client devices in the group, i.e., Orange County, may download the message while other client devices may discard the message. The client devices in the group may then compile the requested profile information. At some time before the target date/time, client devices in the group that received the request may establish a connection with the host 102 and transmit the requested profile information to the host 102. The host 102 may identify malfunctioning client devices in response to the compiled client profiles received from the Orange County client devices. Using this information, the host 102 may generate a new, narrower group including only the malfunctioning Orange County client devices. The host 102 may then generate one or more messages that include a software maintenance software module in the payload portion(s) 204 and the new group identifier in the header portion(s) 202. The malfunctioning Orange County client devices may download the maintenance software and repair the problem.

The flow of the operations described in FIGS. 3, 4, and 6 is exemplary, and blocks in the flowcharts may be skipped or performed in different order according to alternate embodiments.

A number of embodiments have been described. Nevertheless, it will be understood that various modifications may be made without departing from the spirit and scope of the invention. Accordingly, other embodiments are within the scope of the following claims.

What is claimed is:

1. A method comprising:
formatting a request message including a group identifier and a request;
transmitting the request message to a plurality of client devices over a first communication channel; and
receiving a response to the request message from client devices identified by the group identifier over a second communication channel.

2. The method of claim 1, further comprising:
dynamically grouping two or more of said clients into a second group having a second group identifier.

3. The method of claim 2, further comprising:
transmitting the second group identifier to the plurality of client devices; and
storing the second group identifier at each client in the second group.

4. The method of claim 2, further comprising:
formatting a second request message including the second group identifier and a request.

5. The method of claim 1, wherein transmitting the request message comprises broadcasting the request message.

6. The method of claim 1, further comprising:
transmitting an acknowledgement signal over the second communication channel to the clients that transmitted the response.

7. A method comprising:
storing a group identifier identifying membership in a group of two or more clients;
receiving a request message from a host over a first communication channel, said request message including the group identifier and a request; and
transmitting a response to the request message to the host over a second communication channel.

8. The method of claim 7, further comprising:
waiting for an acknowledgement signal from the host over the second communication channel; and
retransmitting the response over the second communication channel in response to not receiving the acknowledgement signal within a time period.

9. The method of claim 7, wherein the request message comprises a request for client profile information.

10. The method of claim 9, further comprising compiling the requested client profile information,
wherein transmitting the response comprises transmitting the requested client profile information.

11. An article comprising a machine-readable medium which stores machine-executable instructions, the instructions causing a machine to:
format a request message including a group identifier and a request;
transmit the request message to a plurality of client devices over a first communication channel; and
receive a response to the request message from client devices identified by the group identifier over a second communication channel.

12. The article of claim 11, further comprising instructions causing the machine to:
dynamically group two or more of said clients into a second group having a second group identifier.

13. The article of claim 12, further comprising instructions causing the machine to:
transmit the second group identifier to the plurality of client devices; and
store the second group identifier at each client in the second group.

14. The article of claim 12, further comprising instructions causing the machine to:
format a second request message including the second group identifier and a request.

15. The article of claim 11, wherein the instructions which cause the machine to:
transmit the request message comprise instructions causing the machine to broadcast the request message.

16. The article of claim 11, further comprising instructions causing the machine to:
transmit an acknowledgement signal over the second communication channel to the clients that transmitted the response.

17. An article comprising a machine-readable medium which stores machine-executable instructions, the instructions causing a machine to:
store a group identifier identifying membership in a group of two or more clients;
receive a request message from a host over a first communication channel, said request message including the group identifier and a request; and
transmit a response to the request message to the host over a second communication channel.

18. The article of claim 17, further comprising instructions causing the machine to:
wait for an acknowledgement signal from the host over the second communication channel; and
retransmit the response over the second communication channel in response to not receiving the acknowledgement signal within a time period.

19. The article of claim 17, wherein the request message comprises a request for client profile information.

20. The article of claim 19, further comprising instructions causing the machine to compile the requested client profile information,
wherein the response comprises the requested client profile information.

21. An system comprising:
a broadcast communication channel;
a back communication channel;
a host including
a message generator operative to generate a request message comprising a target identifier in a first portion and a request in a second portion, and
a transmitter to transmit the request message to a plurality of clients over the broadcast communication channel; and
a client including a memory operative to store client profile information,
a client profile agent to compile profile information in response to receiving the request message, and
a transmitter to transmit the compiled profile information to the host over the back communication channel.

22. The system of claim 21, wherein the host further comprises a group generator operative to generate a group including two or more clients and a corresponding group identifier, said target identifier comprising the group identifier.

23. The system of claim 22, wherein the client further comprises:
a membership file to store a membership identifier; and
a receiver controller operative to discard the request message in response to the membership identifier not matching the group identifier.

24. The system of claim 21, wherein the broadcast communication channel comprises at least one of a wireless communication link and a transmission line.

25. The system of claim 21, wherein the back communication link comprises a bi-directional communication link.

26. The system of claim 21, wherein the back communication link has a lower bandwidth than the broadcast communication link.

27. A system of claim 21, wherein the broadcast communication channel comprises a wireless communication link and the second communication channel comprise a transmission line.

28. The system of claim 21, wherein the message generator is further operative to include a target date/time in a third portion of the request message, and
wherein the client further comprises a transmission controller operative to transmit the requested profile information before the target date/time.
